(19) United States
(12) Patent Application Publication
(10) Pub. No.: US 2018/0157397 A1
(43) Pub. Date: Jun. 7, 2018

(54) System and Method for Adding Three-Dimensional Images to an Intelligent Virtual Assistant that Appear to Project Forward of or Vertically Above an Electronic Display

(71) Applicant: Maxx Media Group, LLC, Philadelphia, PA (US)

(72) Inventors: Richard S. Freeman, Philadelphia, PA (US); Scott A. Hollinger, Philadelphia, PA (US)

(73) Assignee: Maxx Media Group, LLC

(21) Appl. No.: 15/826,637

(22) Filed: Nov. 29, 2017

Related U.S. Application Data
(63) Continuation-in-part of application No. 15/481,447, filed on Apr. 6, 2017.
(60) Provisional application No. 62/319,788, filed on Apr. 8, 2016.

(51) Int. Cl. G06F 3/0481; G06F 3/16; G06T 17/00; G10L 15/22; G06F 9/44; G06F 17/30

(52) U.S. Cl. CPC G06F 3/04815; G06F 3/167; G06T 17/00; G10L 2015/223; G06F 9/4446; G06F 17/30277; G10L 15/22

(57) ABSTRACT

A system and method for operating a virtual assistant system run on an electronic device with a visual image representing the virtual assistant. Voice recognition software identifies spoken action commands. The electronic device generates an interface image, such as an avatar, that is displayed. The interface image appears three dimensional and contains enhanced 3D effects that cause the interface image to appear, at least in part, to extend out beyond the screen surface of the electronic device. The interface image is interactive and responds to the spoken commands. For certain spoken commands, a command response image is provided. The command response image is a three-dimensional image or video that contains enhanced 3D effects. The command response image can be recalled from a database or created by recalling an image or video and processing that image or video to first be three-dimensional and then to contain enhanced 3D effect.

### RELATED APPLICATIONS

This application is a continuation-in-part of co-pending patent application Ser. No. 15/481,447, filed Apr. 6, 2017 which claims benefit of Provisional Application No. 62/319,788, filed Apr. 8, 2016.

### BACKGROUND OF THE INVENTION

### 1. Field of the Invention

In general, the present invention relates to systems, methods and software that are used to create intelligent virtual assistants. More particularly, the present invention relates to systems, methods and software that show a vertical or forward projecting three-dimensional visual representation of an intelligent virtual assistant, and vertical or forward projecting three-dimensional images related to information provided by the virtual assistant. The present invention also relates to systems that integrate three-dimensional images with virtual assistant software or with a virtual assistant base station.

### 2. Prior Art Description

People interact with computers for a wide variety of reasons. As computer software becomes more sophisticated and processors become more powerful, computers are being integrated into many parts of everyday life. In the past, people had to sit at a computer keyboard or engage a touch screen to interact with a computer. In today's environment, many people interact with computers merely by talking to the computer. Various companies have programmed intelligent virtual assistants. For example, Apple Inc. has developed Siri® to enable people to verbally interact with their iPhones®. Amazon Inc. has developed Alexa® to enable people to search the World Wide Web and order products through Amazon®. Such prior art systems also allow the user to get helpful information about a wide variety of topics.

Although interacting with a computer via an intelligent virtual assistant is far more dynamic than a keypad or touch pad, it still has many drawbacks. Most intelligent virtual assistants are audio-only interfaces. That is, the intelligent virtual assistant receives commands audibly and presents answers audible. This audio-only communication is fine for simple requests, such as “What time is it?” However, such an audio-only interface is incapable of providing visual information in its responses. Accordingly, using an intelligent virtual assistant would be a very poor choice for answering a question, such as “What does the Eifel tower look like?”

Additionally, audio-only communications are not able to provide a human figure, which would be capable of a much more personalized level of interaction and communication through a wide range of facial expressions and body movements. Such facial expressions and body movements carry a great deal of additional, nuanced meaning beyond the mere spoken word, creating a more advanced level of interaction between human user and virtual assistant.

When interacting with an intelligent virtual assistant, audio answers typically come in the form of a disembodied voice. Attempts have been made to improve the friendliness of intelligent virtual assistants by presenting a visual virtual avatar to accompany the audio. For instance, in U.S. Patent Application Publication No. 2006/0294465 to Ronene, an avatar system is provided for a smart phone. The avatar system provides a face that changes expression in the context of an audio conversation. The avatar can be customized and personalized by a user. A similar system is found in U.S. Patent Application Publication No. 2006/0079325 to Trajkovic, which shows an avatar system for smart phones. The avatar can be customized, where aspects of the avatar are selected from a database.

In U.S. Pat. No. 9,367,869 to Stark, entitled “System And Method For Virtual Display”, a system is disclosed that provides a humanoid avatar to supplement the intelligent virtual assistant being run by a smart phone. An obvious limitation with such prior art systems is that the avatar being viewed is two-dimensional. Furthermore, if a smart phone is being used, the image being viewed is on a screen that may be less than two inches wide. Accordingly, much of the visual information being communicated can be difficult to see and easy to miss.

Little can be done to change the screen size on many devices such as smart phones. However, many of the disadvantages of any two-dimensional avatar can be overcome or minimized by presenting an image that is three-dimensional. This is especially true if the three-dimensional effects designed into the image cause the image to appear to project out of the surface plane of the display. In this manner, the image will appear to stand vertically above, or in front of, the smart phone during a conversation.

In the prior art, there are many systems that exist for creating stereoscopic, auto-stereoscopic and light field images that appear three-dimensional. However, most prior art systems create three-dimensional images that appear to exist behind or below the surface plane of the electronic screen. That is, the three-dimensional effect would cause an image to appear to extend down from and behind the surface plane of the screen of a smart phone or tablet. The screen of the smart phone or tablet would appear as a window atop the underlying three-dimensional virtual image. With any screen, this limits the ability of the 3D image to provide visual communication queues.

A need therefore exists for creating 3D images that can be used to augment an intelligent virtual assistant, wherein the 3D images appear three-dimensional and also appear to extend vertically above or in front of the surface plane of the electronic display from which it is shown. This need is met by the present invention as described and claimed below.

### SUMMARY OF THE INVENTION

The present invention is a system and method for operating a virtual assistant system, which displays a vertical or forward projecting three-dimensional virtual assistant image. The virtual assistant system is run on an electronic device. The electronic device has a processing unit for running software and an electronic display. The electronic display has a screen surface.

Voice recognition software is run on the electronic device that is capable of identifying spoken action commands. The processing unit within the electronic device also generates an interface image, such as a virtual avatar, that is displayed on the electronic display. The interface image appears three-dimensional and contains enhanced 3D effects that cause the interface image to appear, at least in part, to extend vertically above, or in front of, the surface plane of the screen of the electronic device. The interface image is interactive and responds to the spoken action commands identified by the voice recognition software.

For certain spoken action commands, the processing unit either replaces the interface image or supplements the interface image with a secondary command response image. The secondary command response image is a stereoscopic or auto-stereoscopic image, which can be a still photo or video that contains enhanced 3D effects. The enhanced 3D effects cause the secondary command response image to appear to extend vertically above, or in front of, the surface plane of the screen of the electronic display. The secondary command response image can be recalled from a 3D model database. Alternatively, the secondary command response image can be generated by recalling a two-dimensional image or two-dimensional video and processing that image or video to first be stereoscopic, auto-stereoscopic or a light field image and then to contain enhanced 3D effects. The added enhanced 3D effects cause the image or video to appear to extend vertically above, or in front of, the surface plane of the display screen of the electronic device.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is an image of a first prior art intelligent virtual assistant base station;

FIG. 2 is an image of a second prior art intelligent virtual assistant mobile device;

FIG. 3 is a schematic of a prior art intelligent virtual assistant system;

FIG. 4 is an exemplary schematic of the present invention intelligent virtual assistant system;

FIG. 5 is a block diagram showing the method of operation of the present invention intelligent virtual assistant system;

FIG. 6 shows the intelligent virtual assistant system displaying a first exemplary command response image;

FIG. 7 shows the intelligent virtual assistant system displaying a second exemplary command response image;

FIG. 8 shows the intelligent virtual assistant system displaying a third exemplary command response image;

FIG. 9 shows the intelligent virtual assistant system displaying a fourth exemplary command response image;

FIG. 10 shows the intelligent virtual assistant system displaying a fifth exemplary command response image;

FIG. 11 shows the intelligent virtual assistant system displaying a sixth exemplary command response image;

FIG. 12 shows the intelligent virtual assistant system displaying a seventh exemplary command response image;

FIG. 13 shows the intelligent virtual assistant system displaying an eighth exemplary command response image;

FIG. 14 shows the intelligent virtual assistant system embodied in a mobile device and displaying both an interface image and an exemplary command response image; and

FIG. 15 shows the intelligent virtual assistant system embodied in a stationary reception kiosk.

### DETAILED DESCRIPTION OF THE DRAWINGS

Although the present invention system and method can be used to augment a variety of intelligent virtual assistants, only a few exemplary embodiments are illustrated and described. The elected embodiments are selected for the purposes of description and explanation only. Accordingly, the illustrated embodiments are merely exemplary and should not be considered a limitation when interpreting the scope of the appended claims.

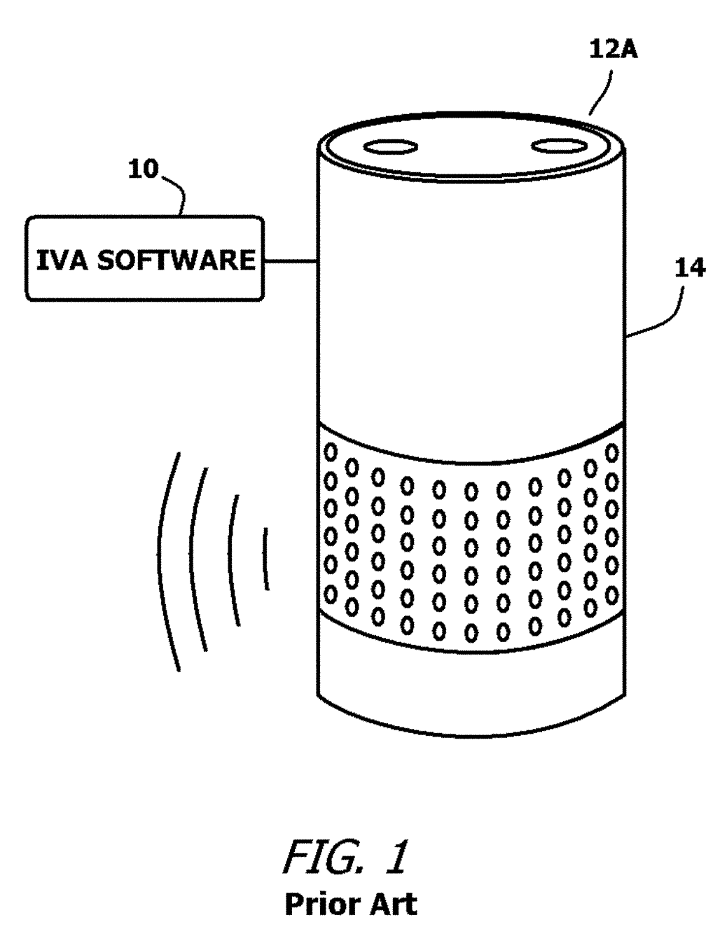

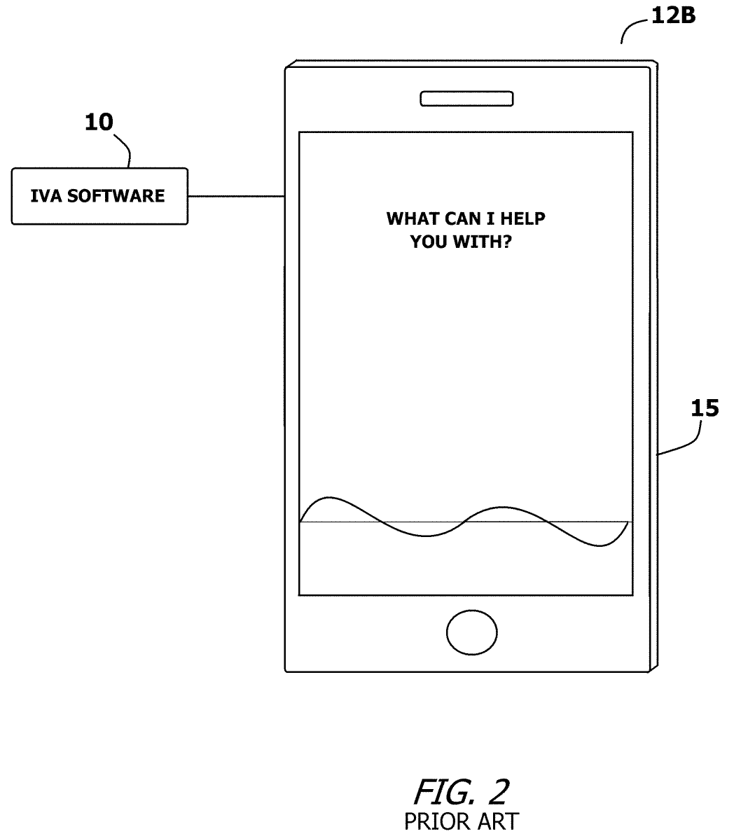

Intelligent virtual assistant (IVA) systems are systems that are run on electronic devices. Referring to FIG. 1 and FIG. 2, two common electronic devices 12A, 12B, are shown that are used to run prior art IVA software 10. In FIG. 1, the electronic device 12A is an Amazon® Echo® base station 14. The electronic device 12A is dedicated to the running of the IVA software 10 and the functioning of the overall IVA system. The electronic device 12A serves no other purpose other than to support the IVA software 10. In FIG. 2, the electronic device 12B is a mobile device, such as a smartphone 15. The IVA software 10 is integrated software, wherein the IVA software 10 is part of the operating software of the smartphone 15. Such integrated IVA software 10 is utilized in Apple® iPhones® as the SIRI® IVA system. In both dedicated IVS systems and integrated IVA systems, the IVA software 10 is audio-based. That is, the IVA system primarily interacts with a user audibly.

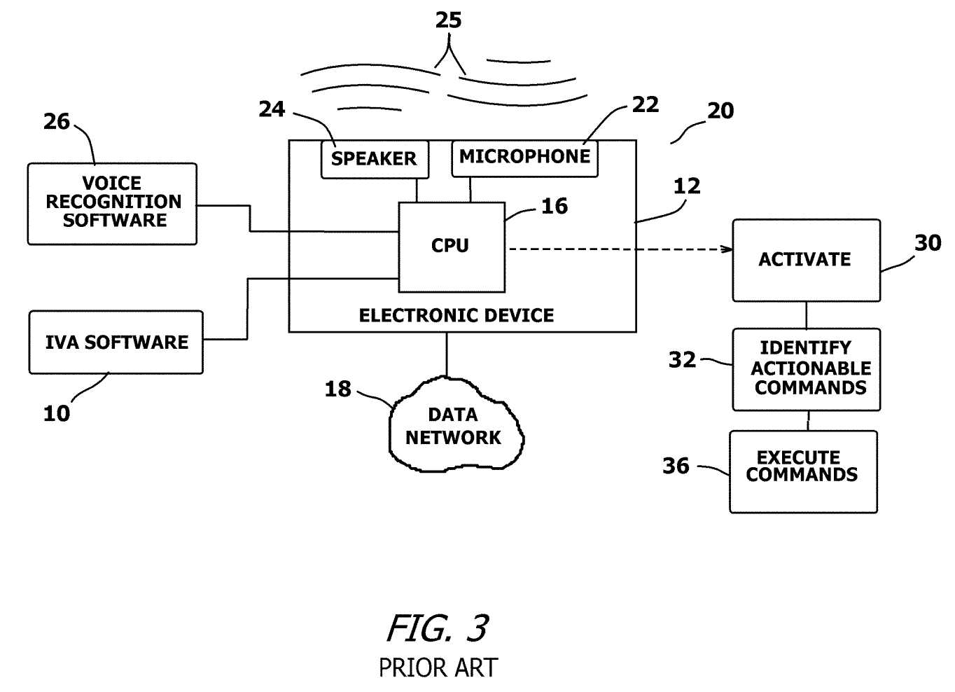

Referring to FIG. 3 in conjunction with FIG. 1 and FIG. 2 it can be seen that the IVA system 20 includes IVA software 10 that is run by a central processing unit 16 within the electronic device 12. The central processing unit 16 communicates with a data network 18, such as a cellular data network or the Worldwide Web. This enables the IVA software 10 to retrieve information in response to a command request. The operation of the IVA software 10 requires that the electronic device 12 have both a microphone 22 and a speaker 24 for receiving and transmitting audio signals 25. During use, a user speaks aloud to the electronic device 12. The spoken words are received by the microphone 22. The spoken words are deciphered using voice recognition software 26 that is run by the central processing unit 28 within the electronic device 12. The spoken words are analyzed for an activation word/phrase. The activation word is typically the name of the IVA system 20, such as Alexa®, Siri® or the like. Once spoken aloud, the IVA system 20 activates and IVA software 10 attempts to identify an actionable command. See Block 30 and Block 32. Different subroutines in the IVA software 10 are dedicated to different actionable commands. Once an actionable command is identified or its parameters triggered, the subroutine corresponding to that actionable command is executed. See Block 36. The actionable commands can be preprogrammed commands or commands that are triggered by words spoken by a user. Preprogrammed commands can be wake-ups alarms, appointment reminders, exercise motivational comments and the like. Actionable commands that are triggered by spoken words are more interactive.

Different IVA systems 20 have different actionable commands. However, the IVA software subroutines assigned to actionable commands tend to fall into several basic categories. Those categories include, but are not limited to, setting commands, media commands, time commands, message commands, list comments, news commands, grammar commands, shopping/purchase commands and query commands.

Setting commands control the settings of the IVA system 10. An example of a setting command would be “increase volume”. If such an actionable command is perceived, a subroutine would be run by the IVA software 10 that would increase the volume to the speaker. Media commands control the selection and playing of audio-based media, such as music and audio books. An example of a media command would be “play playlist”. If such an actionable command is perceived, a subroutine would be run by the IVA software 10 that would begin to audibly play the playlist of the user. Time commands are used for controlling time and date related issues, such as appointment reminders. The most common time demand is “what time is it?” If such an actionable command is perceived, a subroutine would be run by the IVA software 10 that would audibly broadcast the time. Messaging commands are used to send or receive a message, either by text or by phone. An example of a messaging command would be “call home”. If such an actionable command is perceived, a subroutine would be run by the IVA software 10 that initiates a phone call to the phone number identified as “home”. List commands are used to create lists, such as to-do lists and shopping lists. An example of a list command would be “add milk to the shopping list”. If such an actionable command is perceived, a subroutine would be run by the IVA software 10 that would add milk to a virtual shopping list. The shopping list, when needed is audibly communicated to a user. News commands are used to retrieve information from the day's news. An example of a news command would be “what is today's weather?” If such an actionable command is perceived, a subroutine would be run by the IVA software 10 that would audible inform the user as to the day's weather. Grammar commands are used to find proper spelling and definitions. An example of a grammar command would be “how do you spell pizzeria?” If such an actionable command is perceived, a subroutine would be run by the IVA software 10 that would audible spell “pizzeria”. Shopping or purchase commands are used to review or purchase products. An example of a shopping or purchase command would be “show men's shirts” or “order item”. If such an actionable command is perceived, a subroutine would be run by the IVA software 10 that would place an on-line order for an item previously identified. Lastly, query commands are used to obtain specific information about a person, place or thing. Query commands typically come in the form of “who is”, “what is”, or “where is” such as “what is the Eifel tower”?

In all the examples of actionable commands provided above, the communications between the IVA system 20 and the user are audio only. This is even true if the IVA system 20 is integrated into a smartphone 15 with an electronic display. Typically, the only thing displayed on the screen of a smartphone using an IVA software 10 is some simple text and graphic, such as waveform (See FIG. 2), that moves in time with the words being spoken. The graphics communicates no useful information to the user other than showing that the spoken command has been received by the integrated IVA system 20.

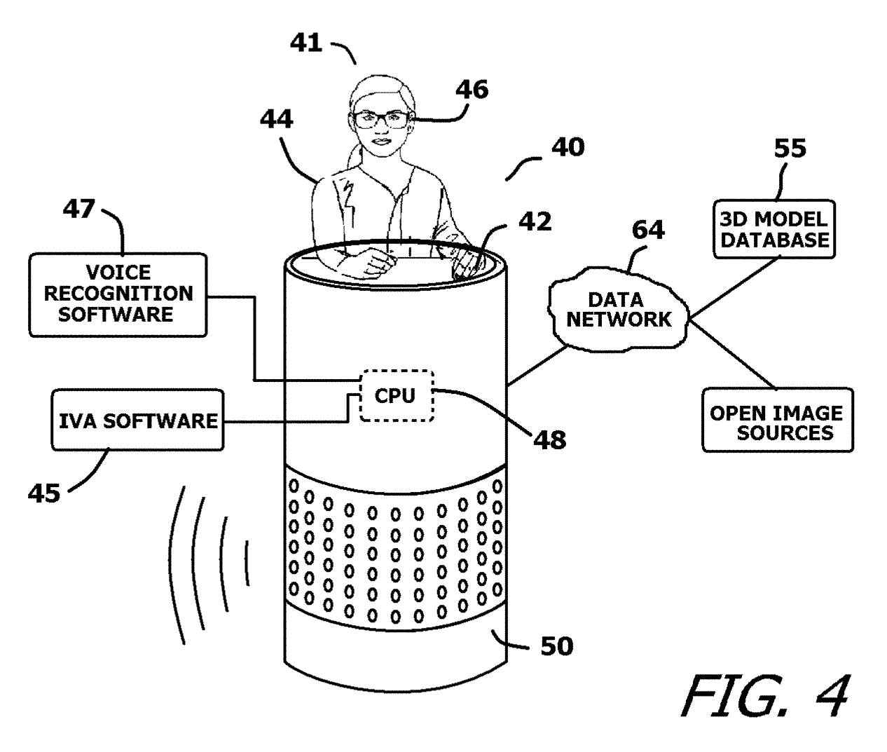

The improved IVA system of the present invention is both audio and visual in nature. The improved IVA system requires the use of an electronic display. If the improved IVA system is integrated with a smartphone, an electronic display is already available. However, if a dedicated IVA system, such as the Amazon® Echo® system is being used, an electronic display has to be provided or a new dedicated IVA system provided that includes a screen. This later configuration is shown in FIG. 4.

Referring to FIG. 4, an IVA system 40 is shown. The IVA system 40 is an electronic device 50 that has a central processing unit 48 and an electronic display 42. The central processing unit 48 runs IVA software 45 and controls the electronic display 42. The electronic display 42 shows virtual images 44 in 3D, as will be explained. The virtual images 44 appear to extend vertically above, or in front of, the screen surface 43 of the electronic display 42 when viewed. Accordingly, the virtual images 44 appear to extend out of the electronic display 42, beyond the screen surface 43, when viewed. In order for the 3D effects of the virtual images 44 to be perceived by the viewer without the use of specialized 3D glasses, the electronic display 42 must be a light field display or some other form of an auto-stereoscopic display. If the electronic display 42 is not auto-stereoscopic, then the 3D glasses must be utilized to perceive the enhanced 3D effects.

In FIG. 4, the virtual image 44 being displayed is the interface image 41 of the IVA system 40. The interface image 41 can be a CGI avatar or an image of a real person that is provided through pre-recorded or live streaming video. The interface image 41 of an avatar or real person image may be preselected by the manufacturer of the IVA system 30. However, in the use of an avatar, which may be in the likeness of a human, animal, robot or any other object, it is preferred that a 3D model for the avatar 46 be personally created by the user. In this manner, each user can customize the avatar 46 presented by the IVA system 40 to his/her own preferences. The methodology used to customize a 3D model of an avatar is disclosed in co-pending U.S. patent application Ser. No. 15/482,699, entitled “System, Method And Software For Producing Virtual Three Dimensional Avatars That Actively Respond To Audio Signals While Appearing To Project Forward Of Or Above An Electronic Display”, the disclosure of which is herein incorporated by reference.

Likewise, in the use of a real person as the interface image 41, it is possible that many different real person images may be available to be selected by the user. In this manner, each user can select the real person image presented by the IVA system 40 to best suit his/her own preferences. The methodology used to produce a real person image is disclosed in co-pending U.S. patent application Ser. No. 15/665,423, entitled, “System, Method And Software For Producing Live Video Containing Three-Dimensional Images That Appear To Project Forward Of Or Vertically Above A Display”, the disclosure of which is herein incorporated by reference.

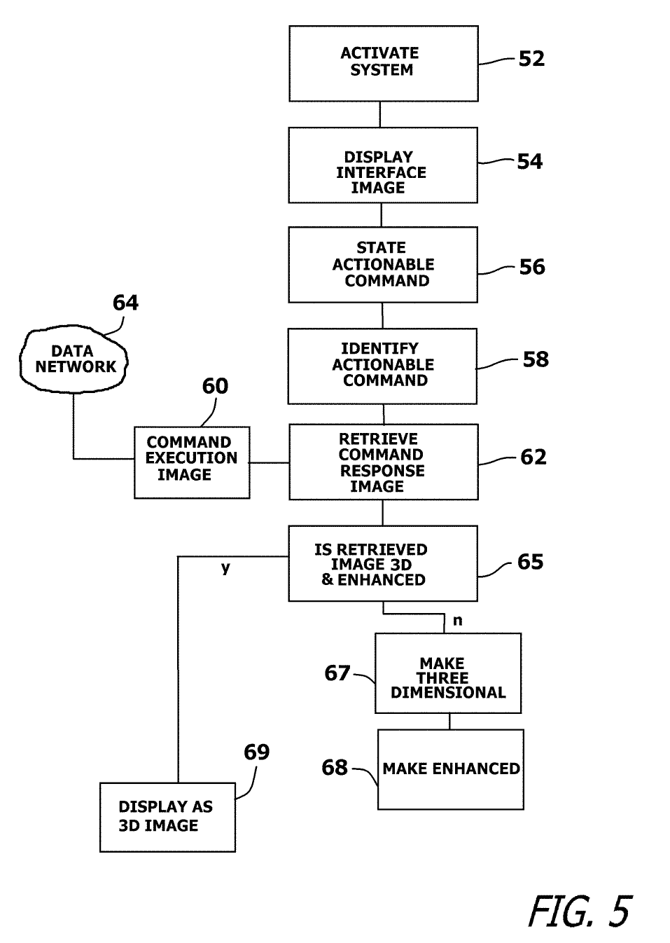

Referring to FIG. 5 in conjunction with FIG. 4, it will be understood that to operate the improved IVA system 40, a user first activates the IVA system 40. See Block 52. This can be done in various ways, such as powering up the IVA system 40 or simply stating an activation command, such as the name of the IVA system 40. Once activated, the 3D model of the interface image 41 appears at the electronic display 42. See Block 54. The appearance of the interface image 41 at the electronic display 42 informs the user that the IVA system 40 is ready for an actionable command. The user then verbally states an actionable command, which is captured by the voice recognition software 47 being run by the central processing unit 48 within the electronic device 50. See Block 56. The IVA system 40 uses voice recognition subroutines to identify the stated command. See Block 58.

Once a stated command is identified by the IVA system 40, the interface image 41 is replaced in whole or in part with a secondary command response image 60. See Block 62. The secondary command response image 60 presented depends upon which type of action command was voiced. The secondary command response image 60 can be either generated by the IVA system 40 or retrieved through a data network 64. In each instance, the secondary command response image 60 must be an enhanced three-dimensional image or three-dimensional video in order to appear to extend vertically above, or in front of, the electronic display 42.

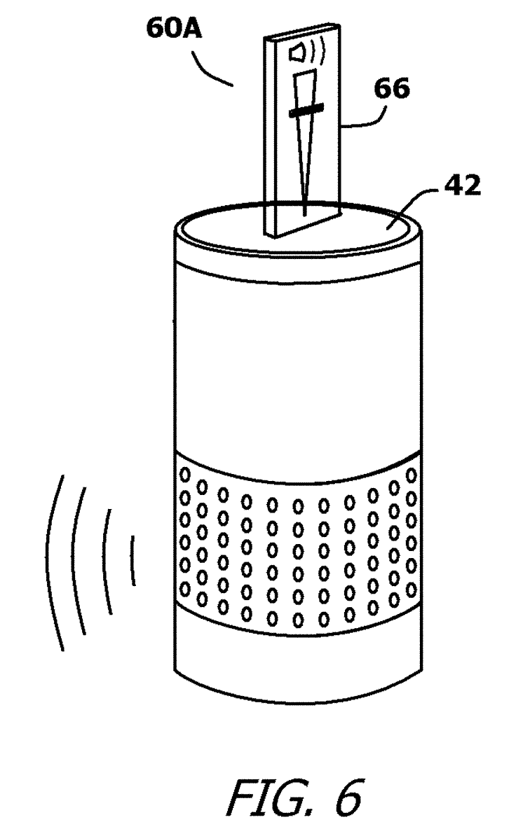

Referring to FIG. 6 in conjunction with FIG. 4 and FIG. 5, an exemplary secondary command response image 60A for a system command is shown. For this example, the system command may be “increase volume”, as previously stated. For this actionable command, a 3D image of a virtual volume scale 66 appears either with the interface image 41 or in place of the interface image 41. Such scales are often used in adjusting volume on 2D displays. Accordingly, a user can quickly ascertain the current volume and changes in volume by looking at the secondary command response image 60A. The secondary exemplary command response image 60A may appear stationary, or can be made to move, such as with a slow rotation.

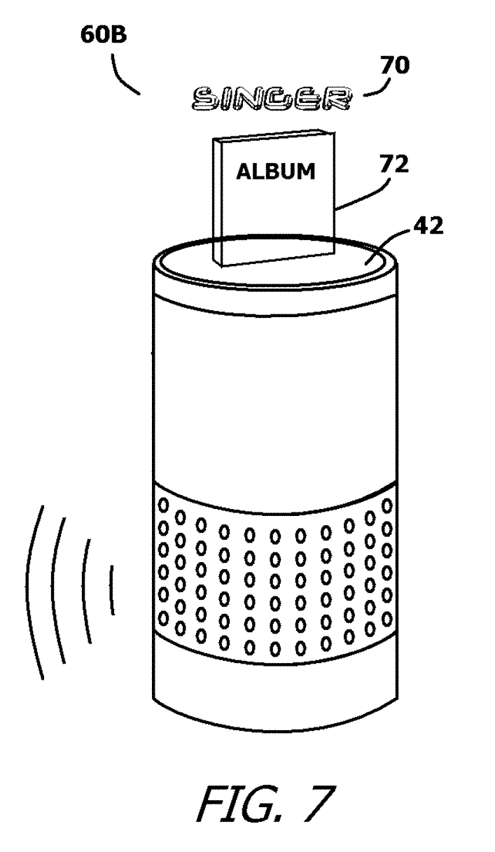

Referring to FIG. 7, an example is provided for the secondary command response image 60B for a media command. If the media command were “play playlist” as previously speculated, then the secondary command response image 60B may be the name of a song 70 on that playlist accompanied by an image 72 of the album cover from the album that contains that song or the artist performing the song. If the song has a corresponding music video, the secondary command response image 60B can be the music video, altered to appear 3D and enhanced to extend above or in front of the electronic display 42.

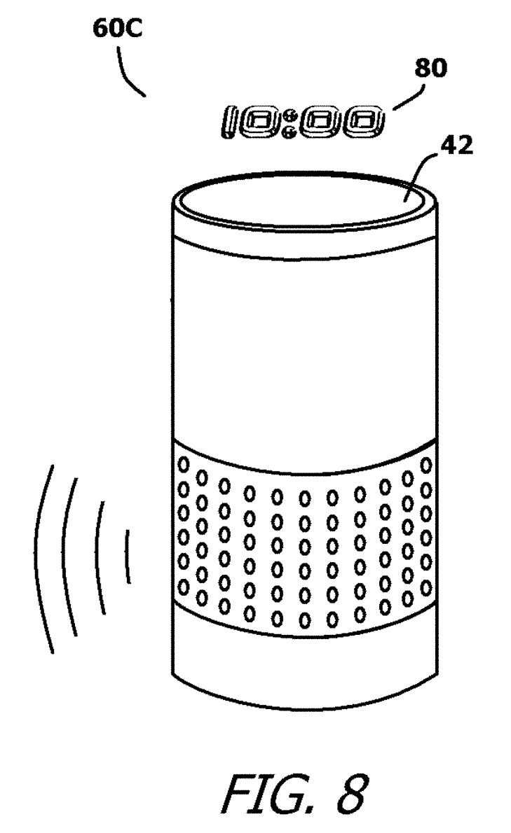

Referring to FIG. 8, an example is provided for the secondary command response image 60C for a date command. If the time command were “what time is it?” as previously speculated, then the secondary command response image 60C would show an image 80 of the current time. All images would have enhanced 3D effects that cause the secondary command response image 60C to appear 3D and extend vertically above or in front of the electronic display 42.

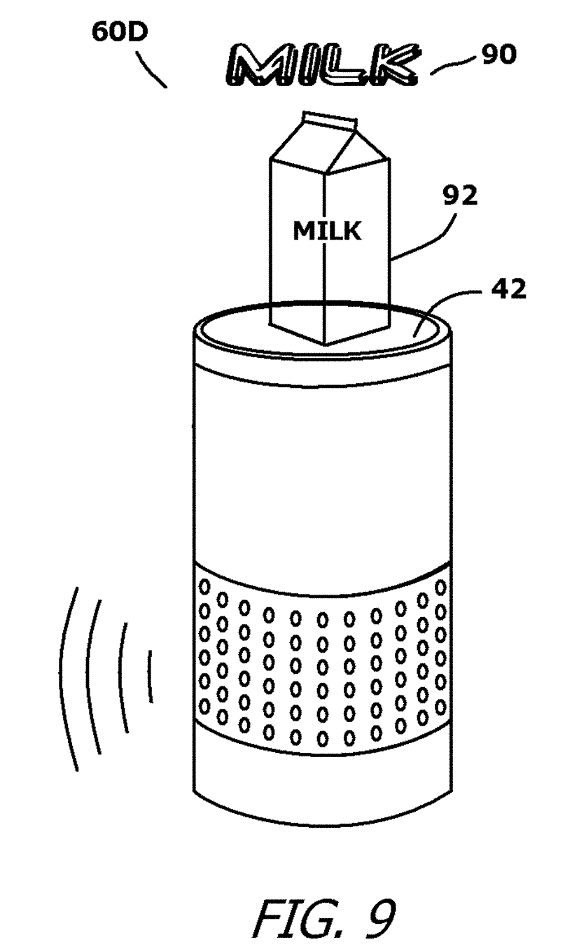

Referring to FIG. 9, an example is provided for the secondary command response image 60D for a list command. If the list command were “add milk to the shopping list” as previously speculated, then the secondary command response image 60D would show the word milk 90 and an image of a milk carton 92 would be displayed. All images have enhanced 3D effects that cause the secondary command response image 90 to appear 3D and extend vertically above or in front of the electronic display 42.

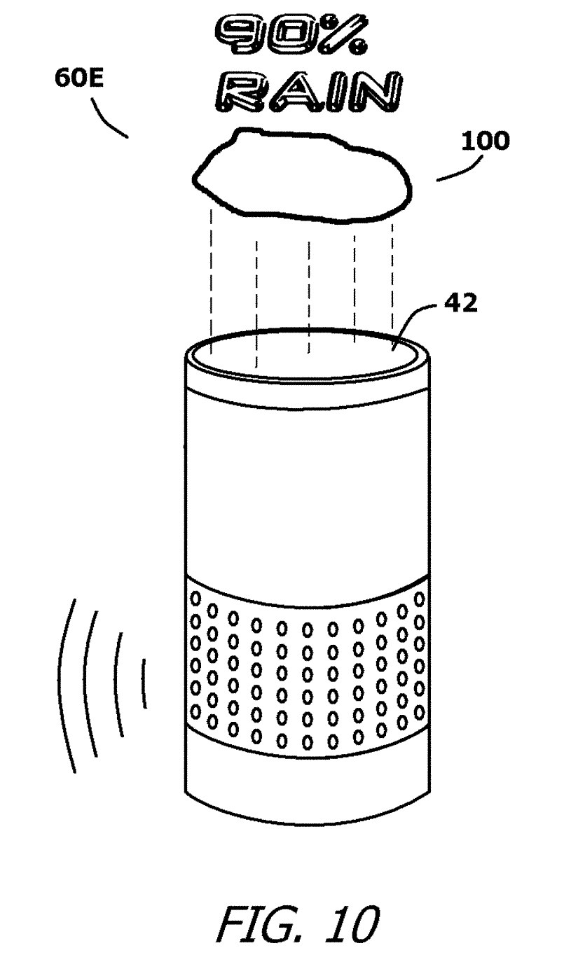

Referring to FIG. 10, an example is provided for the secondary command response image 60E for a news command. If the news command were “what is today's weather” as previously speculated, then the secondary command response image 60E would show an image 100 of a forecast graphic. The secondary command response image 60E would have enhanced 3D effects that cause the secondary command response image 60E to appear 3D and extend vertically above or in front of the electronic display 42.

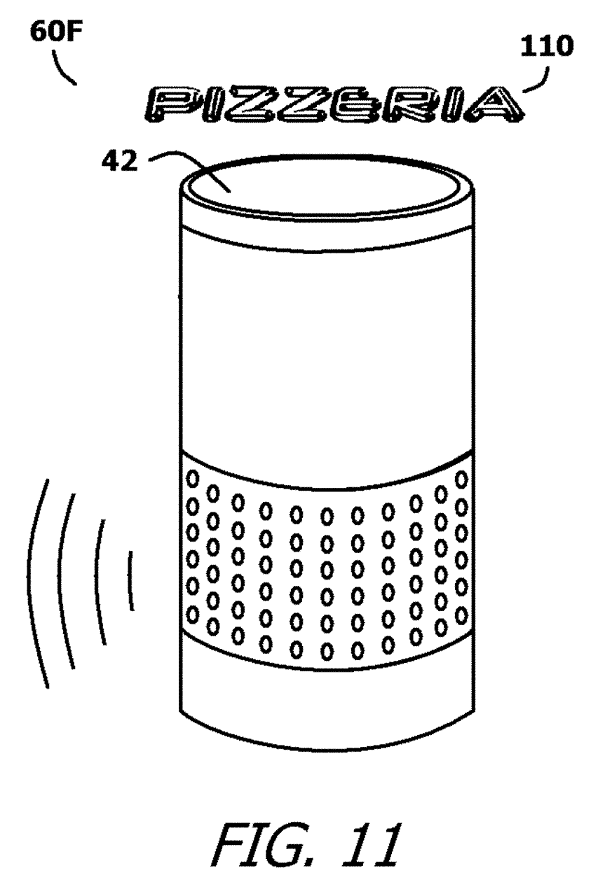

Referring to FIG. 11, an example is provided for the secondary command response image 60F for a grammar command. If the entertainment command were “how do you spell pizzeria” as previously speculated, then the secondary command response image 60F may be an image 110 of the word pizzeria. The secondary command response image 60F would have enhanced 3D effects that cause the secondary command response image 120 to appear 3D and extend vertically above or in front of the electronic display 42.

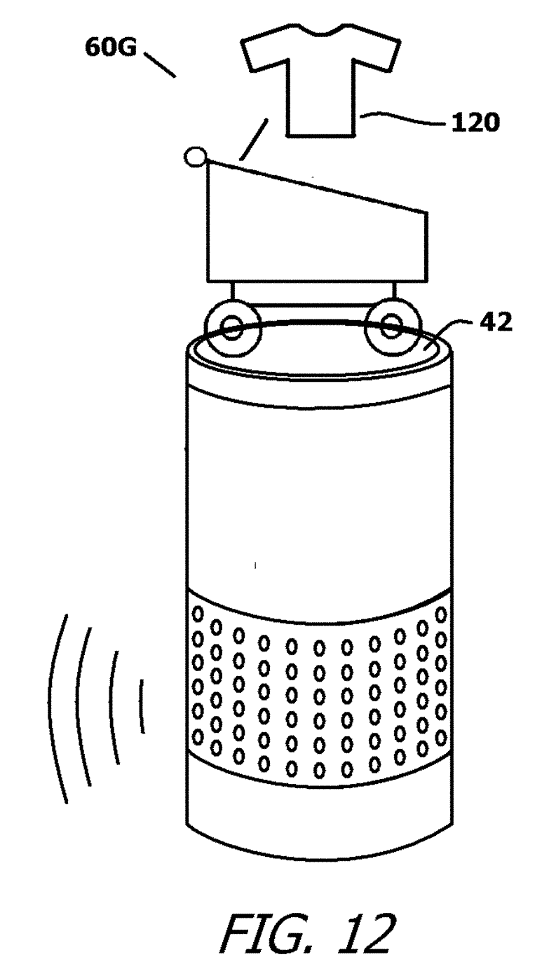

Referring to FIG. 12, an example is provided for the secondary command response image 60G for a shop and purchase command. If the shop or purchase command 60G were “shop” and/or “place order” as previously speculated, then the secondary command response image 60G may be images 120 of the items being reviewed during shopping or items being purchased. The secondary command response image 60G would have enhanced 3D effects that cause the secondary command response image 60G to appear 3D and extend vertically above or in front of the electronic display 42.

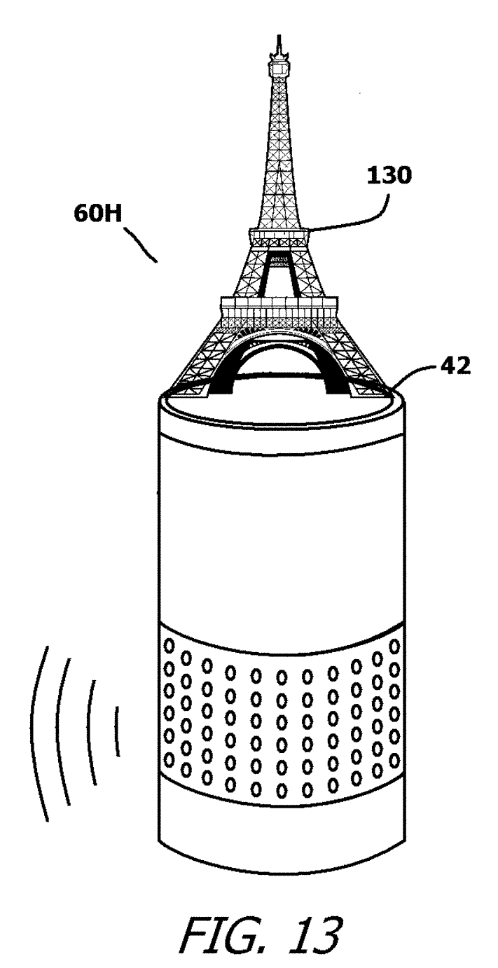

Referring to FIG. 13, an example is provided for the secondary command response image 60H for a query command. If the query command were “what is the Eifel Tower?” as previously speculated, then the secondary command response image 60H may be an image 130 of the Eifel tower. The secondary command response image 60H would have enhanced 3D effects that cause the secondary command response image 60H to appear 3D and extend vertically above or in front of the electronic display 42. In all of the examples of the secondary command response images shown 60 in FIG. 6 through FIG. 13, it is desired that secondary command response image 60 be a three-dimensional image with enhanced 3D effects that cause the secondary command response image 60 to appear to extend vertically above or in front of an electronic display 42, depending upon the orientation of the electronic display 42. In order to produce enhanced 3D effects on a three-dimensional image, a three-dimensional image must first be obtained. For virtual images, virtual 3D models can be imaged in different ways to create a 3D image. For example, the virtual 3D model can be imaged stereoscopically or can be imaged as a light field image. The interface image 41 is based upon a virtual 3D model so it is very straightforward to image the 3D model to produce 3D images. Likewise, it is not complicated to produce virtual 3D models of common graphics, such as numbers, letters and words that can be stored in a 3D model database. Accordingly, obtaining a three-dimensional image of the current time is as simple as recalling the 3D models of various numbers from a 3D model database.

Difficulties occur when a 3D model is needed of an obscure person, place or thing. For example, if a person where to ask the IVA system, “who was Abraham Lincoln's youngest child?”, the IVA system may be able to retrieve information and images of Tad Lincoln. However, all images would probably be two-dimensional photographs or sketches. No preexisting three-dimensional images or 3D models would likely be available.

If an appropriate 3D model is not available in the 3D model database, the present invention IVA system 40 locates appropriate 2D images and/or 2D videos via the data network 64. The present invention IVA system 40 then converts 2D images and/or 2D video into three-dimensional images and or a three-dimensional video. Once the image or video is converted into a three-dimensional image or three-dimensional video, then the enhanced 3D effects can be added to the three-dimensional image or three-dimensional video that make the image or video appear to extend vertically above or in front of an electronic display 42.

There are many prior art systems that exist for converting a two-dimensional image into a three-dimensional image. Some systems view the two-dimensional image stereoscopically. Other systems project the two-dimensional image onto a three-dimensional surface. Still other systems image the two-dimensional image with a light field camera. Examples of such prior art systems are shown in U.S. Pat. No. 9,407,904 to Sandrew, entitled “Method For Creating 3D Virtual Reality From 2D Images” and U.S. Patent Application Publication No. 2016/0065939 to Kim, entitled “Apparatus, Method, And Medium Of Converting 2D Image To 3D Image Based On Visual Attention”. Likewise, there are several prior art systems for converting a two-dimensional video into a three-dimensional video. Such prior art techniques are exemplified by U.S. Pat. No. 9,438,878 to Niebla, entitled “Method Of Converting 2D Video To 3D Video Using 3D Object Models”.

Once a two-dimensional image or a two-dimensional video has been converted to a three-dimensional image or a three-dimensional video using a prior art technique, then enhanced 3D effects are added to the three-dimensional image or the three-dimensional video that causes the image or video to appear to project vertically above, or in front of, the electronic display on which the image or video is being viewed. The process of adding such enhanced 3D effects to a three-dimensional image or three-dimensional video is disclosed in co-pending U.S. application Ser. No. 15/481,447, entitled System Method And Software For Producing Virtual Three Dimensional Images That Appear To Project Forward Of Or Above An Electronic Display; and co-pending U.S. patent application Ser. No. 15/665,423, entitled, “System Method And Software For Producing Live Video Containing Three-Dimensional Images That Appear To Project Forward Of Or Vertically Above A Display”, the disclosures of which are herein incorporated by reference.

Referring back to FIG. 5 in conjunction with FIG. 4 and FIG. 6, the methodology utilized by the IVA system 40 can now be explained in full. Once activated, the IVA system 40 presents an interface image 41. See Block 52 and Block 54. The interface image 41 has enhanced 3D effects that cause it to appear to project vertically above, or in front of, an electronic display 50. Using voice recognition software 47, the IVA system 40 listens for and identifies an action command. See Block 56 and Block 58. In performing the action command, the IVA system 40 retrieves a secondary command response image 60. See Block 62. The secondary command response image 60 must be three-dimensional and have enhanced 3D effects in order to project vertically above or in front of the electronic display 42 like the interface image 41. Some secondary command response images 60 and/or videos, are maintained in a 3D model database 55. If these images and/or videos are needed as the secondary command response image 60, then they are simple recalled from the 3D model database 55.

If a secondary command response image 60 is needed that is not within the 3D model database 55, then that secondary command response image is obtained through the data network 64. If an enhanced three-dimensional image or video can be found on-line, then that image or video is used directly. See Block 65. If the only subject appropriate image is a 2D image or a 2D video, then the 2D image/video is converted in a two-step process. In a first step, the 2D image/video is converted into a three-dimensional image or video using known methodologies. See Block 67. Once converted to be three-dimensional, enhanced 3D effects are added to the image and/or video in a second step. See Block 68. The enhanced three-dimensional image and/or video is then displayed, wherein the enhanced three-dimensional image and/or video appears to project vertically above, or in front of the electronic display. See Block 69.

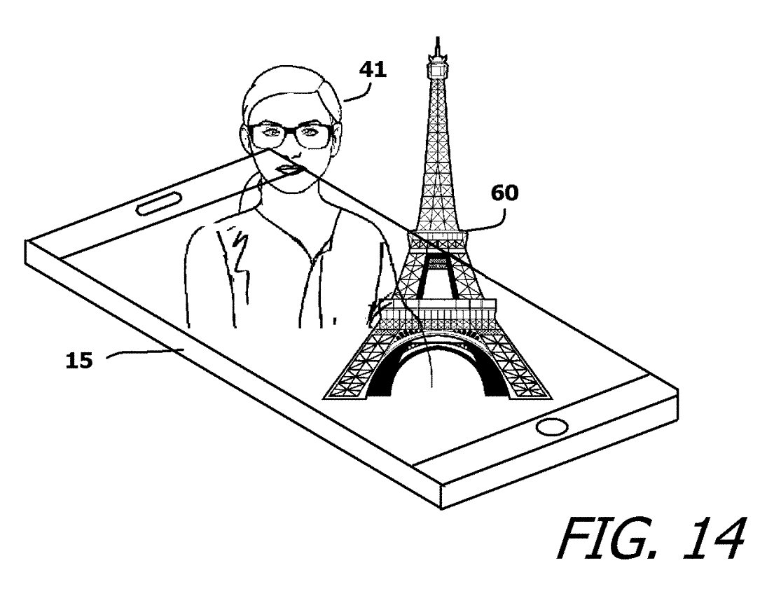

In FIG. 6 through FIG. 13, the IVA system 10 is shown running on an Amazon® Echo® base station 14. Also, the interface image 41 and secondary command response image 60 need are shown as being displayed separately. This need not be the case. The present invention IVA system can run on any electronic device that runs intelligent virtual assistant software. Also, multiple images, such as both the interface image and the secondary command response image 60 can be displayed at the same time. Referring to FIG. 14, this is shown. In FIG. 14 the electronic device is shown as a smartphone 15. The smartphone is displaying both an interface image 41 and a secondary command response image 60 of the Eifel tower.

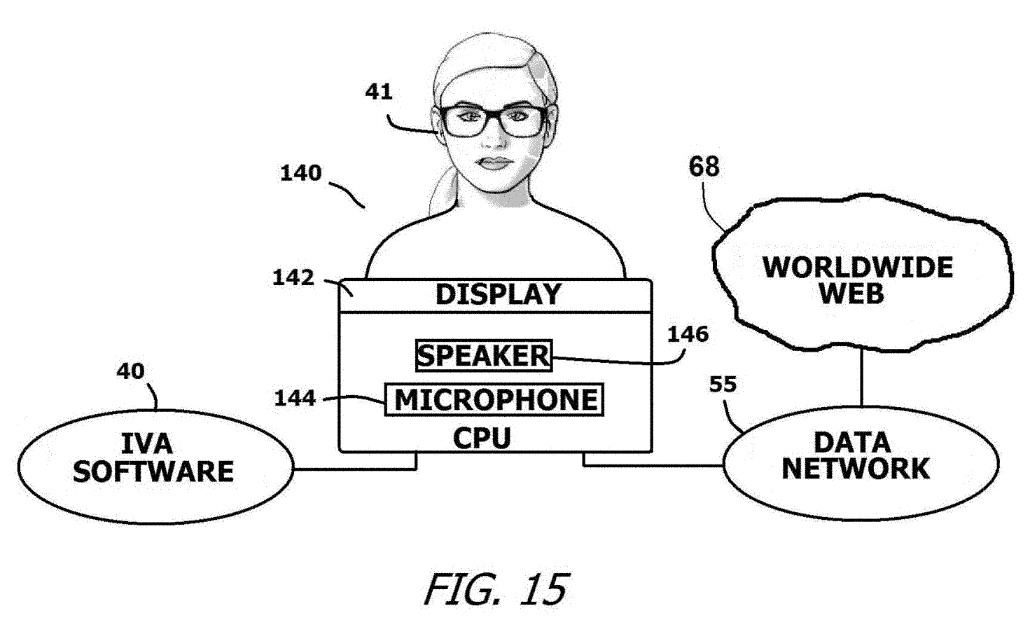

In the previous embodiments, the intelligent virtual assistant is played through a small electronic device, such as a smartphone and an Amazon® Echo®. However, this need not be the case. Referring to FIG. 15 in conjunction with FIG. 3, an example is provided where a user can utilize a stationary system. In FIG. 15, an exemplary reception station 140 is shown. The reception station 140 may be the concierge desk at a hotel, an information desk at a hospital, a kiosk in an amusement park or any such reception station where people would normally ask questions. The reception station 140 is unmanned and contains a display 142, a microphone 144 and a speaker 146. The display 142 here is preferably an auto-stereoscopic display that utilizes parallax barrier, lenticular, light field technology or any other auto-stereoscopic display based on any technology capable of showing three-dimensional images without the need for specialized glasses.

The reception station 140 is connected to a data network 55 and contains the integrated IVA system 40. A user approaches the reception station 140 and speaks. Once activated, the integrated IVA system 40 displays an interface image 41 that interacts with the user. The user can query the interface image 41, wherein integrated IVA system 40 uses voice recognition to identify an action command. Once the action command is identified, the action command is executed. If the action command requires no more than a verbal answer, then the interface image 41 may merely states that verbal answer. If the action command is better responded to using a secondary command response image 60, then the virtual image of the interface image 41 is with replaced with or augmented with a secondary command response image 60. As such, the user is provided with both useful audible and visual information.

It will be understood that the embodiments of the present invention that are illustrated and described are merely exemplary and that a person skilled in the art can make many variations to those embodiments. All such embodiments are intended to be included within the scope of the present invention as defined by the claims.

What is claimed is:

1. A virtual assistant system, comprising:
an electronic display having a screen surface, that displays an interface image, wherein said interface image appears three dimensional and contains enhanced 3D effects that cause said interface image to appear, at least in part, to extend out beyond said screen surface of said electronic device; and
a processing unit that runs voice recognition software capable of detecting spoken commands, wherein said processing unit controls and generates said interface image.

2. The virtual assistant system according to claim 1, wherein said processing unit communicates with a data network.

3. The virtual assistant system according to claim 1, wherein different subroutines are assigned to said spoken commands, wherein said processing unit act to run at least one of said subroutines when one of said subroutines are detected by said voice recognition software.

4. The virtual assistant system according to claim 3, wherein at least some of said different subroutines cause a command response image to be displayed on said electronic display.

5. The virtual assistant system according to claim 4, wherein said command response image is a three-dimensional image with said enhanced 3D effects that cause said command response image to appear, at least in part, to extend out beyond said screen surface of said electronic device.

6. The virtual assistant system according to claim 3, wherein said command response image is retrieved by said processing unit through said data network.

7. The virtual assistant system according to claim 3, further including a 3D model database accessible by said processing unit, wherein said command response image is retrieved from said 3D model database.

8. The virtual assistant system according to claim 3, wherein said command response image is a three-dimensional image with said enhanced 3D effects created by altering a two-dimensional image.

9. A method of operating a virtual assistant system, comprising:
providing an electronic device having a processing unit and an electronic display, wherein said electronic display has a screen surface;
running voice recognition software on said electronic device that can identify spoken action commands;
displaying an interface image on said electronic display that is generated by said processing unit, wherein said interface image appears three dimensional and contains enhanced 3D effects that cause said interface image to appear, at least in part, to extend out beyond said screen surface of said electronic device, and wherein said interface image is interactive and responds to said spoken action commands identified by said voice recognition software.

10. The method according to claim 9, wherein said processing unit communicates with a data network.

11. The method according to claim 10, wherein different subroutines are assigned to said spoken commands, wherein said processing unit act to run at least one of said subroutines when one of said subroutines are detected by said voice recognition software.

12. The method according to claim 10, wherein different subroutines are programmed into said processing unit, wherein said processing unit automatically runs at least one of said subroutines when a programmed event occurs.

13. The method according to claim 11, wherein at least some of said different subroutines cause a command response image to be displayed on said electronic display.

14. The method according to claim 12, wherein said command response image is a three-dimensional image with said enhanced 3D effects that cause said command response image to appear, at least in part, to extend out beyond said screen surface of said electronic device.

15. The method according to claim 12, wherein said command response image is retrieved by said processing unit through said data network.

16. The method according to claim 12, further including a 3D model database accessible by said processing unit, wherein said command response image is retrieved from said 3D model database.

17. The virtual assistant system according to claim 12, wherein said command response image is a two-dimensional image and said method further includes converting said two-dimensional image into a three-dimensional image.

18. The virtual assistant system according to claim 17, further includes enhancing said three-dimensional image with 3D effects that cause said three-dimensional image to appear, at least in part, to extends out beyond said screen surface of said electronic display.

19. A method of operating a virtual assistant system, comprising:
providing an electronic device having a processing unit and an electronic display, wherein said electronic display has a screen surface;
displaying an interface image on said electronic display, wherein said interface image appears three dimensional and contains enhanced 3D effects that cause said interface image to appear, at least in part, to extend above said screen surface of said electronic device, and wherein said interface image is interactive and responds to a spoken action command; and
replacing said interface image with a command response image in response to said spoken action command.

20. The method according to claim 12, wherein said command response image is a three-dimensional image with said enhanced 3D effects that cause said command response image to appear, at least in part, to extend out beyond said screen surface of said electronic device.

21. The method according to claim 20, wherein said command response image is retrieved by said processing unit through a data network.
